(19) United States
(12) Patent Application Publication
(10) Pub. No.: US 2024/0393299 A1
(43) Pub. Date: Nov. 28, 2024

(54) INSERTION SEALING DEVICE FOR A CHROMATOGRAPHY COLUMN

(71) Applicant: Waters Technologies Corporation, Milford, MA (US)

(72) Inventors: Michael Scanlon, Sharon, MA (US); Joseph D. Michienzi, Plainvile, MA (US); Wade P. Leveille, Douglas, MA (US)

(21) Appl. No.: 18/669,944

(22) Filed: May 21, 2024

Related U.S. Application Data
(60) Provisional application No. 63/469,220, filed on May 26, 2023.

(51) Int. Cl. G01N 30/60; B01D 15/22

(52) U.S. Cl. CPC G01N 30/6026; B01D 15/22

(57) ABSTRACT

A device for sealing to a chromatographic column includes an insertion body and a tip assembly. The insertion body has an attachment end, a tip opposite to the attachment end and a fluidic channel extending between the attachment end and the tip. An attachment feature located near the attachment end secures the insertion body to an actuator. An axially movable sheath may be provided at the tip to protect the tip assembly prior to and during coupling to a column end nut and to assist in aligning the device to the column end nut. The device can be loaded by manual clamping or by an automated clamp mechanism to achieve sufficient force for a fluid tight seal in the column end nut. Devices are column agnostic and may be used in a column oven to enable a chromatography system to be quickly configured with a wide variety of columns.

### RELATED APPLICATION

This application claims the benefit of the earlier filing date of U.S. Provisional Patent Application Ser. No. 63/469,220 filed May 26, 203 and titled “Insertion Sealing Device for a Chromatography Column” the entirety of which is incorporated herein by reference.

### FIELD OF THE INVENTION

The disclosed technology relates generally to chromatography columns. More particularly, the technology relates to a device for insertion sealing of a chromatography column that can be used with a variety of clamping mechanisms.

### BACKGROUND

Separation systems and devices, including chromatography systems and devices, are used to separate a mixture into its constituents. Chromatography systems include High Performance Liquid Chromatography (HPLC) systems, Ultra Performance Liquid Chromatography (UPLC) systems, and Supercritical Fluid Chromatography (SFC) systems. HPLC systems may use high pressures which typically range from approximately 7 MPa (1,000 psi) to approximately 40 MPa (6,000 psi), to generate the fluid flow required for liquid chromatography (LC) in packed columns. UPLC systems typically use columns with smaller particulate matter and generally require higher pressures which may approach 172 MPa (25,000 psi). SFC systems may use highly compressible mobile phases, which often includes carbon dioxide as a principal component.

HPLC and UPLC systems, as used for example for clinical and bio-processing applications, are evolving toward easier to use systems with user-friendly operating features; however, column replacement continues to be a challenge. Users often have tightly controlled test procedures in which the column chemistry is critical. Columns from different manufacturers may have different configurations and often cannot easily be installed in a given chromatography system. Often, columns have end nuts with an industry standard thread and a flat bottom port. Other aspects of the end nuts, such as port dimensional differences, can make installation of the column into an LC system difficult or impractical.

A chromatographic column is generally coupled into an LC system by coupling tubing to each end nut using a threaded fitting. The threads in the end nuts are used to generate the sealing force. The process of completing the connection can be tedious and subject to error. For example, if the connection is not correctly completed due to improper threading between the fitting and the end nut or due to inadequate torque applied to make the connection, the connection may leak. Additionally, any fitting dead volume remaining after the connection is made can result in degraded measurement data. For example, if the end of the tube is not in contact with the flat bottom of the end nut port, a large dead volume is present in the connection. In another example, the threaded fitting may include a cone-shaped sealing surface that can be damaged during installation or removal, leading to leaks or degraded chromatographic performance. Moreover, the ability to adapt a column from one manufacturer for use in an LC system from another manufacturer may require specialized connection techniques and represents a substantial installation time and cost.

### SUMMARY

In one aspect, a device for sealing to a chromatographic column includes an insertion body having an attachment end, a tip opposite to the attachment end and a fluidic channel extending between the attachment end and the tip. The insertion body has an attachment feature near or at the attachment end to secure the insertion body to an actuator. The device further includes a tip assembly attached to the tip of the insertion body. The tip assembly includes a sealing element disposed in the assembly and used to engage a sealing surface of the chromatographic column.

The insertion body may have an outer surface wherein the attachment feature is a threaded region of the outer surface. The insertion body may include a rim on the outer surface.

The tip assembly may further include a collar circumferentially disposed about the sealing element.

The insertion body may include an outer body having an axial bore and an outer surface having the attachment feature and may further include a fluidic tube that defines the fluidic channel disposed in the axial bore.

The insertion body may include an outer body having an axial bore and an outer surface having the attachment feature and may further include a sleeve that defines the fluidic channel secured in the axial bore. The tip assembly may be attached at an end of the sleeve. A fluidic tube may be disposed in the sleeve and define the fluidic channel.

The device may further include an actuator secured to the attachment end of the insertion body where the actuator is configured to apply an axial force to the insertion body to force the sealing element against the sealing surface of the chromatographic column.

The device may further include a chromatographic column having an end nut. The tip assembly and at least a portion of the insertion body may be disposed within a port of the end nut so that the sealing element engages a sealing surface of the end nut. The outer diameter of the insertion body may be less than an inner diameter of a threaded port of the end nut.

The device may further include a sheath disposed over a portion of a length of the insertion body, wherein the sheath has a sheath axis, a first sheath end, a second sheath end and an opening extending along the sheath axis from the first sheath end to the second sheath end. The sheath may have an outer surface having a tapered portion at the second sheath end. The device may further include a coil spring disposed in the opening between an internal surface of the sheath and the first sheath end. The sheath may be axially movable from an extended position in which the sheath extends over the sealing element and a retracted position in which the coil spring is compressed so that so that the sealing element at the end of the tip of the insertion body is exposed. The sheath may be made of plastic. The tapered portion of the outer surface of the sheath may be configured to engage a conical surface of the port in the end nut.

The insertion body may include a first body to which the tip assembly is attached at one end and a second body comprising a nut having an axial bore and being secured to the other end of the first body, wherein an outer surface of the nut includes the attachment feature.

In another aspect, a clamping system for sealing to a chromatographic column includes a pair of devices for scaling to a chromatography column. The devices are arranged in opposing directions to each other along a system axis. Each device includes an insertion body and a tip assembly. The insertion body has an attachment end, a tip opposite the attachment end and a fluidic channel extending between the attachment end and the tip. The insertion body has an attachment feature proximate to the attachment end. The tip assembly is attached to the tip of the insertion body and includes a sealing element to engage a sealing surface of the chromatographic column. The clamping system further includes a first and a second fluidic assembly. Each of the first and second fluidic assemblies is secured to a respective one of the devices at the attachment end and has a fluidic channel port on the system axis. At least one of the first and second fluidic assemblies is axially movable toward and away from the other one of the first and second fluidic assemblies.

The clamping system may include a column oven enclosing the pair of devices and the first and second fluidic assemblies.

The clamping system may further include an actuator secured to the attachment end of the insertion body of the first fluidic assembly. The actuator is configured to apply an axial force to the insertion body of the first fluidic assembly to force the respective sealing element against the respective sealing surface of the chromatographic column.

The clamping system may further include a sheath and a coil spring. The sheath is disposed over a portion of a length of the insertion body and has a sheath axis, a first sheath end, a second sheath end and an opening extending along the sheath axis from the first sheath end the second sheath end. The sheath has an outer surface having a tapered portion at the second sheath end. The coil spring is disposed in the opening between an internal surface of the sheath and the first sheath end. Each sheath may be axially movable from an extended position in which the sheath extends over the sealing element and a retracted position in which the coil spring is compressed and the sheath is retracted to expose the sealing element.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is a block diagram of an example of a separation system.

FIG. 2 illustrates an example of a separation device with end fittings.

FIG. 3 is a cross-sectional illustration of an example of a device for sealing to a chromatography column.

FIG. 4A is a perspective view of the device of FIG. 3 as provided with an optional sheath.

FIG. 4B is a cross-sectional side view showing the device of FIG. 4A with the sheath in an extended position.

FIG. 4C is a cross-sectional side view showing the device of FIG. 4A with the sheath in a retracted position.

FIG. 5 is a cross-sectional illustration of the device of FIG. 4A coupled to an end nut of a chromatography column.

FIG. 6 is a cross-sectional illustration of an example in which the attachment end of the insertion body of the device shown in FIG. 5 is coupled to an external fluidic channel through a face seal.

FIG. 7A is a perspective view of an alternative example of a device for sealing to a chromatography column which includes a fluidic tube that extends outside the insertion body.

FIG. 7B is a cross-sectional view of the device shown in FIG. 7A.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments and examples disclosed herein are directed to a device for sealing to a chromatographic column. For example, the device may be used as a fluidic coupling that couples a fluidic path or fluidic device to the column. The device includes an insertion body and a tip assembly. The insertion body has an attachment end, a tip opposite the attachment end and a fluidic channel extending between the attachment end and the tip. An attachment feature is located proximate to the attachment end and is used to secure the insertion body to an actuator. An axially movable sheath may be provided at the tip to protect the tip assembly prior to and during coupling to a column end nut and helps to properly align the device to the end nut.

Advantageously, the device is independent of the clamp mechanism used to couple to the chromatographic column. The internal threads of the column end nuts are not used to make the fluidic connection and the device can be used to fluidically connect a column to a host LC system in a variety of ways. An axial load applied to the device ensures that the face seal at the tip of the device achieves a fluid tight connection at the column end nut. The device is column agnostic as long as the tip of the device fits inside the port of the column end nut and the end nut has a port having a flat bottom. The device can be loaded by manual clamping or by an automated clamp mechanism that may rely, for example, on electronic, pneumatic, hydraulic and/or mechanical mechanisms as long as sufficient force is applied to maintain a fluid tight seal in the column end nut.

Advantageously, a chromatography column can be adapted for use in a variety of LC systems regardless of the configuration (e.g., internal port diameter and threads) of the column end nuts. Installation of the column can be performed quickly without requiring the use of installation tools. Devices may be provided as a component in a column oven to enable the chromatography system to be quickly configured with columns from a range of column manufacturers.

Various terminology is used in the description below. As used herein, an “insertion body” means a structural component configured to be at least partially inserted into a port of a receiving component. The insertion body may be made as a single piece or may be made of two or more pieces attached together. The receiving component may be an end nut at the inlet end or outlet end of a chromatography column. The port may include an internal threaded opening in the end nut. An “attachment feature” means a structural element or a surface feature used to engage a complimentary structural element or feature on a separate body or component. For example, the attachment feature may be a threaded surface used to engage a complimentary threaded surface on the other body.

Although explained more specifically in the examples described below, the term “actuator” generally refers to a body or component that can be secured or attached to the device and used to transfer a force to the device. A “fluidic assembly” means a component (or multiple components assembled together) that includes a fluidic channel to conduct a fluid. The fluidic assembly may be fluidically coupled to another fluidic assembly or component to conduct fluid therebetween. For example, a fluidic assembly may be a component having a fluidic channel to deliver fluid to or receive fluid from a device for sealing to an end nut of a chromatography column.

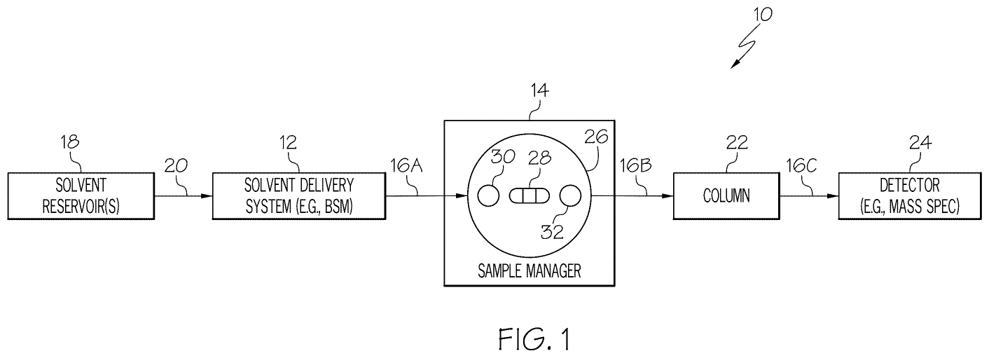

FIG. 1 shows an example of an LC system 10. The system 10 includes a solvent delivery system 12 in fluidic communication with a sample manager 14 (which may also be referred to as an injector or autosampler) through a fluidic tube 16A. The solvent delivery system 12 may include pumps (not shown) in fluidic communication with solvent reservoir(s) 18 from which the pumps draw solvents through one or more fluidic conduits 20, which may be a fluidic line, tube or channel. It should be noted that while the term “tube” is used herein for illustrative purposes to describe the techniques and features of the present disclosure, other fluidic conduits or channels are also within the scope of the present disclosure. The LC system 10 further includes a chromatography column 22 in fluidic communication with the sample manager 14 through a fluidic tube 16B. A fluidic tube 16C couples the output port of the chromatography column 22 to a detector 24. By way of non-limiting examples, the detector 24 may be a mass spectrometer or a UV detector.

The detector 24 receives the separated components from the chromatography column 22 and produces an output from which an identity and quantity of analytes may be determined. As described herein, at various locations in the LC system 10, the fluidic tubes 16A, 16B, and 16C (generally 16) may be coupled to system components using high pressure fittings. Each fluidic tube 16 may refer to a section of tubing or a single tube. Each tubing section may include one tube or multiple tubes joined in series (e.g., by valves, tees, etc.).

The sample manager 14 includes an injector valve 26 with a sample loop 28. The sample manager 14 may operate in one of two states: a load state and an injection state. In the load state, the injector valve 26 is configured so that the sample manager 14 loads the sample into the sample loop 28. In the injection state, the injector valve 26 is configured so that sample manager 14 introduces the sample in sample loop 28 into continuously flowing mobile phase arriving from the solvent delivery system 12. With the injector valve 26 in the injection state, the mobile phase carries the sample to the chromatography column 22. To accomplish this, the mobile phase arrives at the injector valve 26 through an input port 30 and leaves the injector valve 26 with the sample through an output port 32.

Various fittings may be present within the LC system 10. For example, such fittings may be present where fluidic tube 16A connects to the input port 30 of the injector valve 26, where fluidic tube 16B connects to the output port 32 of the injector valve 26 and to an inlet side of chromatography column 22, and where fluidic tube 16C connects to the outlet side of the chromatography column 22 and to the detector 24.

The chromatography column 22 may include a column end nut at the inlet side and another column end nut at the outlet side. Each end nut may be a threaded ferrule style fitting designed in part to create a seal between the end nut and the chromatography column 22. By way of non-limiting examples, an end nut may be round or hexagonally shaped, made from stainless steel, and may be about a half-inch to an inch in length. End nuts may be anywhere from one-quarter inch in diameter to three or more inches in diameter for preparatory style separation devices. End nuts may be torqued onto the remainder of the chromatography column 22 to maintain a fluidic seal with the intervening column components in order for the column 22 to operate at high pressures.

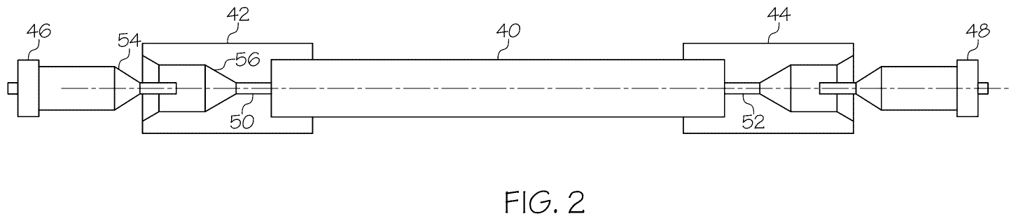

Referring to FIG. 2, an example separation device (chromatography column 40) with end fittings is shown. The column 40 may include column end fittings such as column end nuts 42 and 44. The end nuts 42 and 44 may be threaded and receive threaded connecting fittings 46 and 48, respectively. For example, column end nut 42 may have a female threaded portion with a cone-shaped portion and connecting fitting 46 may have a male threaded portion and a cone-shaped portion.

The connecting fittings 46 and 48 may form seals with the column end nuts 42 and 44 such that fluidic passages 50 and 52 in the end nuts 42 and 44 are in fluidic communication with tubes in the connecting fittings 46 and 48, but fluid is prevented from leaking outside the fluidic passages 50 and 52. The sealing surfaces between the threaded fittings (e.g., column end nut 42 and connecting fitting 46) may be cone-shaped or conical surfaces (e.g., sealing surfaces 54 and 56).

In order to make the seal, torque is applied to the threaded connecting fitting 46 or 48 to generate enough surface stress on the surface of the cone. For example, connecting fitting 46 may be received by column end nut 42 with sufficient torque to form a seal such that fluid is prevented from leaking out near passage 50 on the inlet side of chromatography column 40. Similarly, connecting fitting 48 may be received by column end nut 44 with enough torque to form a seal such that fluid is prevented from leaking out near passage 52 on the outlet side of chromatography column 40.

In alternative configurations, the end nuts are configured to receive a face seal. The face seal may be integrated with an end nut or provided as part of a connection component that mates with the end nut. Column end nuts may employ face seals to improve sealing, promote case of use and facilitate reusability of a chromatography column. Face seals reduce the potential for leaks, sample carryover and sample dispersion. Examples of such face seals are described in US Patent Publication No. 2021/0339166 A1 published Nov. 4, 2021 and titled “Seal for Separation Device,” the entirety of which is incorporated herein by reference.

In the configurations described above, the connection fitting used to couple to the chromatography column through an end nut is required to be compatible with the end nut. For example, the diameter, length and threads on the connection component must be compatible with corresponding features in the end nut port. Thus, LC systems provided by one manufacturer may not be compatible with columns provided by a different manufacturer.

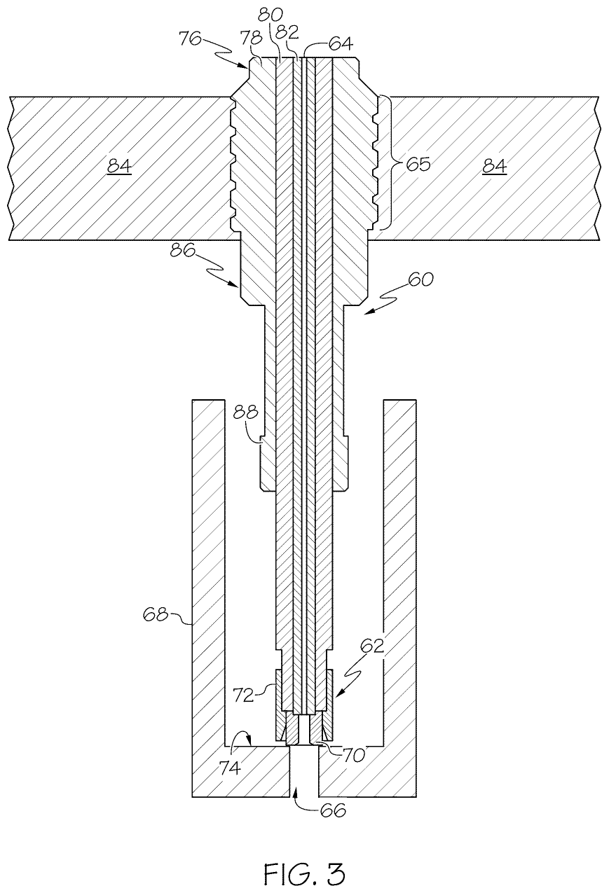

FIG. 3 is a cross-sectional illustration of a device for sealing to a chromatography column. The device includes an insertion body 60 and a tip assembly 62. The insertion body 60 has an attachment end (broader end at top) and a tip that is opposite to the attachment end. The insertion body 60 includes a fluidic channel 64 that extends along a device axis from the attachment end to the tip. The insertion body 60 further includes an attachment feature that is proximate to the attachment end. In the illustrated example, the attachment feature is a threaded region 65 formed on an outer surface 76 of the insertion body 60 proximate to the attachment end. The attachment feature 65 secures the insertion body 60 to an actuator 84. A hexagonal portion 86 of the insertion body 60 may be used to secure (e.g., tighten by wrench) the device to the actuator 84. The tip assembly 62 is attached at the end of the tip of the insertion body 60 and is configured to form a seal at a sealing surface of an inlet end nut or outlet end nut on the column. The diameter of the tip of the insertion body 60 is less than the smallest diameter of the port defined in the end nut 68.

As illustrated, the sealing surface is an internal surface 74 of an end nut 68. A scaling clement (face seal 70) disposed in a collar 72 of the tip assembly 62 engages the sealing surface 74. The sealing element 70 has a central opening to pass the liquid conducted to or from the fluidic channel 64. In the illustrated example, the collar 72 is circumferentially disposed about the sealing element 70 although, in other implementations, other means for positioning the sealing element 70 in proper location with respect to the insertion body 60 may be used. In some implementations, the tip assembly 62 is removable and allows for convenient replacement with another tip assembly. For example, the tip assembly 62 may be replaced after extended use or in situations where the sealing element 70 may exhibit wear. In other implementations, it may be more practical to replace the entire device when the sealing element 70 exhibits wear.

The illustrated insertion body 60 is formed of multiple parts: an outer body 78 and a sleeve 80. The outer body 78 includes an axial bore and has an outer surface 76 with the threaded attachment feature 65. The sleeve 80 is secured in the axial bore and defines the fluidic channel 64. The tip assembly 62 is attached at the end of the sleeve 80. A fluidic tube 82 disposed in the sleeve 80 defines the fluidic channel 64; however, in some other embodiments, the fluidic tube 82 is disposed directly in a narrower axial bore without an intervening sleeve. In another alternative embodiment, the insertion body is a single part without an axial bore and the fluidic channel is formed along the device axis of the single part.

To create a seal with the chromatography column, the tip of the device is inserted into the end nut 68 and an axial force is applied by the actuator 84. For example, the actuator 84 may move the device toward the end nut 68. Once the sealing clement 70 is in contact with the sealing surface 74, additional actuator movement axially compresses the sealing element 70 to form a fluid tight seal between the fluidic channel 64 and the axial channel 66 in the end nut 68.

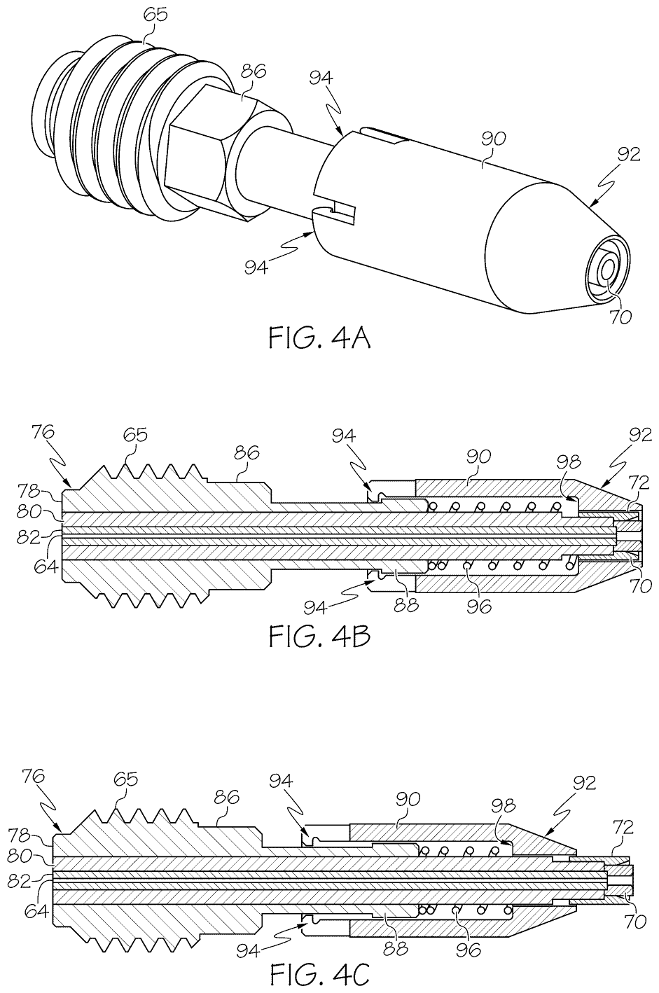

FIG. 4A is a perspective view of the device of FIG. 3 as provided with an optional sheath 90 that can be used to protect the seal 70 and collar 72 of the tip assembly 62 prior to and during installation. FIGS. 4B and 4C are cross-sectional side views showing the sheath 90 in an extended position and a retracted position, respectively. The sheath is axially movable between the extended and retracted positions. Although the sheath 90 is not required, various benefits are realized by using the device with the sheath 90.

The sheath 90 may be made of a plastic material or the like. For example, the sheath 90 made be made of a thermoplastic polymer such as polyether ether ketone (PEEK). In addition to protecting the sealing element 70 and collar, the sheath 90 helps to guide the device during insertion into the end nut and to maintain the device in proper position once installed. Further, the sheath 90 prevents damage to the sealing surface and internal threaded and conical surfaces of the end nut during insertion. Advantageously, after decoupling the device, the column may be reused with the same device, a different device, or a conventional connection fitting.

The sheath 90 has a cylindrical outer surface at one end and a tapered surface 92 at the other end. For example, the tapered surface 92 may be a conical taper having a cone angle that is similar to the cone angle of the mating end nut. The tapered surface 92 helps to guide and center the device as it is inserted into the end nut port. Closely matched cone angles enable the axis of the sheath 90 to be substantially colinear with the center axis of the end nut and ensures that the loading force on the sealing element 70 is substantially perpendicular to the internal sealing surface. Additionally, protection is provided when the device is removed from the column end nut, for example, for device replacement or to use the device with another column.

An opening through the sheath 90 extends along a sheath axis from a first (larger diameter) end to a second end at the at the narrow end of the tapered surface 92. The opening has a larger diameter inside the sheath 90 along an axial region under most or all of the cylindrical surface and a smaller diameter along the axial region under most or all of the tapered surface 92. A coil spring 96 is disposed in the opening between an internal surface 98 and the first end.

The sheath 90 can be attached to the device by sliding its first end over the tip assembly 62 until flexible tabs 94 pass over and then capture a rim 88 formed on the insertion body 60. The rim 88 may be fully concentric about the axis of the insertion body 60 or may include one or more rim components arranged circumferentially about the axis. When the sheath 90 is attached, the coil spring 96 occupies a length of the opening between the rim 88 and the internal surface 98. The coil spring 96 may be relaxed or under minor compression in this extended position of the sheath 90.

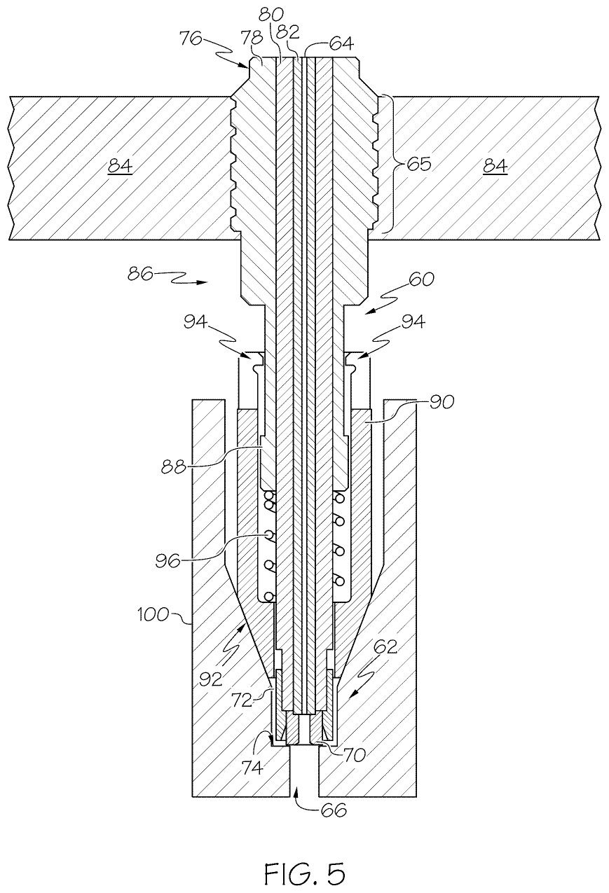

Reference is also made to FIG. 5 which depicts the device coupled to an end nut 100 of a chromatography column. Prior to insertion into the end nut port, the sheath 90 is in the extended position (see FIG. 4B) where the sealing element 70 and collar 72 are protected. As the device is inserted into the column nut port, the tapered portion 92 comes into contact with an internal conical surface of the end nut 100. As the actuator 84 continues to apply an axial force, further movement of the sheath 90 into the port is prevented while the insertion body 60 continues to move toward the sealing surface 74. During this process, the rim 88 compresses the coil spring 96 until the sealing element 70 engages the sealing surface 74 as shown in FIG. 5. Additional force applied by the actuator 84 causes further downward movement of the insertion body 60 and results in axial compression of the sealing element 70 to achieve a fluid-tight seal. When removing the device from the end nut 100, the coil spring 96 expands to move the sheath 90 into the extended position to protect the sealing element 70 and collar 72.

It should be noted that some end nuts do not have an internal conical surface. A device equipped with a sheath 90 can still be used to achieve a fluidic seal as the internal sealing surface provides the axial force to push the sheath 90 and expose the sealing element 70 to the internal scaling surface.

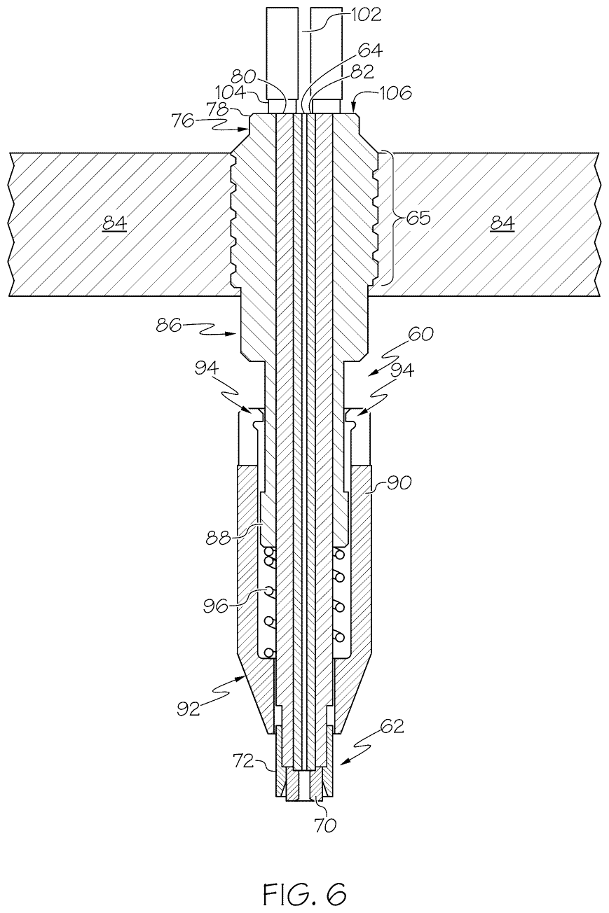

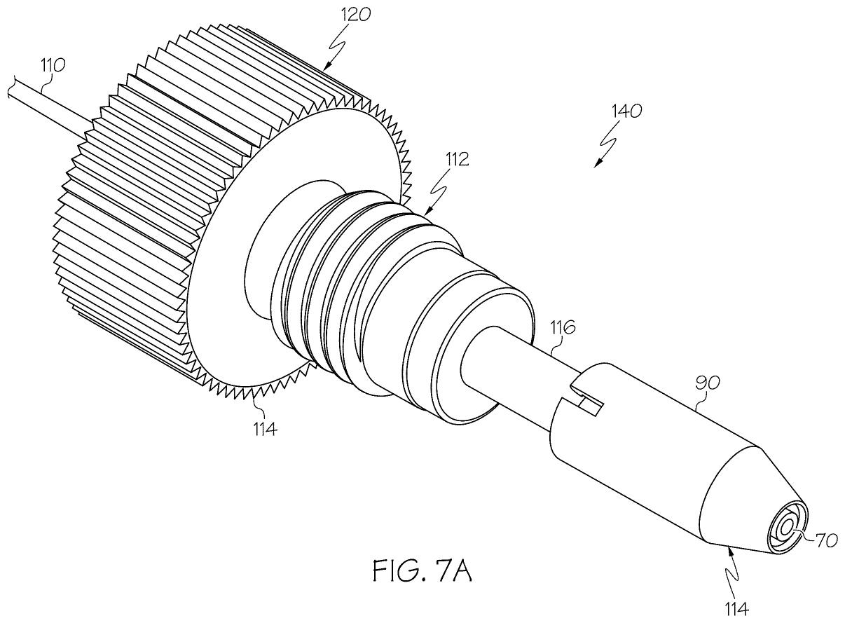

In the above examples, the device for sealing to a chromatographic column is shown attached to an actuator; however, no component for supplying liquid to the device nor any component for conducting liquid from the device is shown. For example, no external fluidic channel is shown for fluidic coupling to the column end nut through the device. In this regard, FIG. 6 is a cross-sectional view showing one example in which the attachment end of the insertion body 60 is coupled to an external fluidic channel 102 through a face seal 104 disposed against a sealing surface 106 at the top end of the device. For example, the external fluidic 102 channel may be part of an active pre-heater (APH) assembly. Advantageously, only the device is replaced when the sealing element 70 is worn, thereby avoiding the need to replace the more expensive APH assembly.

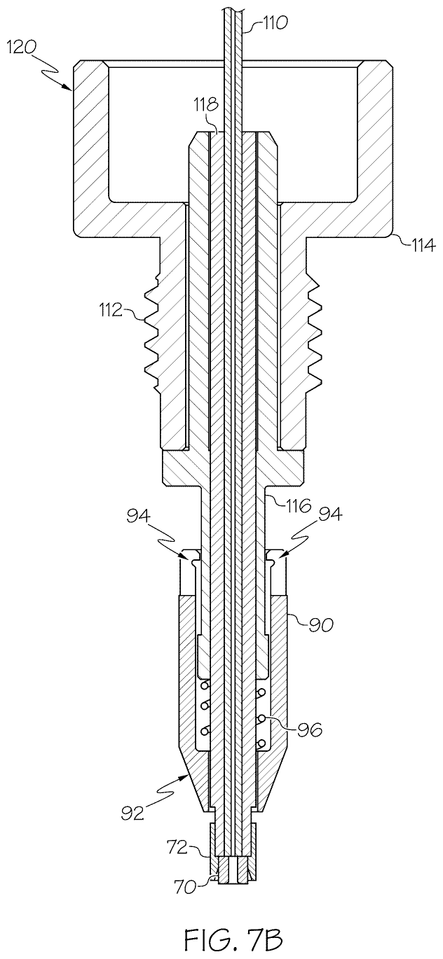

FIGS. 7A and 7B are perspective and cross-sectional views, respectively, showing an alternative embodiment of a device for sealing to a chromatographic column. The device includes a sheath 90 which is shown in an extended position in FIG. 7A and in a retracted position in FIG. 7B. The device is differentiated from the device of FIG. 3 by replacement of the fluidic tube 82 with a fluidic tube 110 that extends outside the insertion body to a remote fitting or component (not shown). Additionally, the insertion body includes an inner body part 116 coupled to an outer body part (nut 114). The outer body part 114 surrounds the upper portion of the inner body part 116 and sleeve 118. Although an actuator is not shown, threads 112 for securing the device to an actuator are provided on a portion of the outer surface of the nut 114. A different portion of the outer surface 120 of the nut 114 away from the threads 112 may be a knurled surface to allow for an easy grip for finger tightening.

Devices such as those described above may be provided as part of a chromatography column oven. Alternatively, the devices may be part of a stand-alone clamping system which may be used to achieve insertion sealing to chromatography columns and similar separation components or more generally to fluidic components requiring high pressure fluid tight connections. For example, the clamping system may include a pair of devices arranged in opposing directions to each other along a system axis. The system may further include a first fluidic assembly secured to the attachment end of one of the devices and a second fluidic assembly secured to the attachment end of the other device. Each fluidic assembly has a fluidic channel port (e.g., one end of a fluidic channel) disposed on the system axis. At least one of the first and second fluidic assemblies is axially movable toward and away from the other fluidic assembly, allowing a column or other fluidic component to be positioned between the two devices and fluidically sealed to the fluidic assemblies. This clamping process may be manually performed. Alternatively, the clamping process may be performed using an automated mechanism that utilizes, for example, one or more electronic, pneumatic, hydraulic, or mechanical mechanisms to move one or both fluidic assemblies.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A device for sealing to a chromatographic column, the device comprising:
an insertion body having an attachment end, a tip opposite to the attachment end and a fluidic channel extending therebetween, the insertion body having an attachment feature proximate to the attachment end to secure the insertion body to an actuator; and
a tip assembly attached to the tip of the insertion body and comprising a sealing element disposed therein to engage a sealing surface of the chromatographic column.

2. The device of claim 1, wherein the insertion body has an outer surface and wherein the attachment feature is a threaded region of the outer surface.

3. The device of claim 1, wherein the tip assembly further comprises a collar circumferentially disposed about the sealing element.

4. The device of claim 1, wherein the insertion body comprises:
an outer body having an axial bore and an outer surface comprising the attachment feature; and
a fluidic tube disposed in the axial bore and defining the fluidic channel.

5. The device of claim 1, wherein the insertion body comprises:
an outer body having an axial bore and an outer surface comprising the attachment feature; and
a sleeve secured in the axial bore and defining the fluidic channel, wherein the tip assembly is attached at an end of the sleeve.

6. The device of claim 5, further comprising a fluidic tube disposed in the sleeve and wherein the fluidic tube defines the fluidic channel.

7. The device of claim 1, further comprising an actuator secured to the attachment end of the insertion body, wherein the actuator is configured to apply an axial force to the insertion body to force the sealing element against the sealing surface of the chromatographic column.

8. The device of claim 1, further comprising a chromatographic column having an end nut and wherein the tip assembly and at least a portion of the insertion body are disposed within a port of the end nut so that the sealing element engages a sealing surface of the end nut.

9. The device of claim 8, wherein an outer diameter of the insertion body is less than an inner diameter of a threaded port of the end nut.

10. The device of claim 2, wherein the insertion body comprises a rim on the outer surface.

11. The device of claim 1, further comprising:
a sheath disposed over a portion of a length of the insertion body and having a sheath axis, a first sheath end, a second sheath end and an opening extending along the sheath axis from the first sheath end to the second sheath end, the sheath having an outer surface having a tapered portion at the second sheath end; and
a coil spring disposed in the opening between an internal surface of the sheath and the first sheath end.

12. The device of claim 11, wherein the sheath is axially movable from an extended position in which the sheath extends over the sealing element and a retracted position in which the coil spring is compressed so that the sealing element at the end of the tip of the insertion body is exposed.

13. The device of claim 11, wherein the sheath is made of plastic.

14. The device of claim 11, wherein the tapered portion of the outer surface is configured to engage a conical surface of the port in the end nut.

15. The device of claim 1, wherein the insertion body comprises a first body to which the tip assembly is attached at one end and a second body comprising a nut having an axial bore and being secured to the other end of the first body and wherein an outer surface of the nut includes the attachment feature.

16. A clamping system for sealing to a chromatography column, comprising:
a pair of devices for sealing to a chromatographic column, the devices arranged in opposing directions to each other along a system axis, each of the devices comprising:
an insertion body having an attachment end, a tip opposite the attachment end and a fluidic channel extending therebetween, the insertion body having an attachment feature proximate to the attachment end; and
a tip assembly attached to the tip of the insertion body and comprising a sealing element to engage a sealing surface of the chromatographic column;
a first fluidic assembly secured to one of the devices at the attachment end and having a fluidic channel port on the system axis; and
a second fluidic assembly secured to the other one of the devices at the attachment end and having a fluidic channel port on the system axis,
wherein at least one of the first and second fluidic assemblies is axially movable toward and away from the other one of the first and second fluidic assemblies.

17. The clamping system of claim 16, further comprising an actuator secured to the attachment end of the insertion body of the first fluidic assembly, wherein the actuator is configured to apply an axial force to the insertion body of the first fluidic assembly to force the respective sealing element against the sealing surface of the chromatographic column.

18. The clamping system of claim 16, further comprising for each of the devices:
a sheath disposed over a portion of a length of the insertion body and having a sheath axis, a first sheath end, a second sheath end and an opening extending along the sheath axis from the first sheath end the second sheath end, the sheath having an outer surface having a tapered portion at the second sheath end; and
a coil spring disposed in the opening between an internal surface of the sheath and the first sheath end.

19. The clamping system of claim 18, wherein each of the sheaths is axially movable from an extended position in which the sheath extends over the sealing element and a retracted position in which the coil spring is compressed and the sheath is retracted to expose the sealing element at the end of the tip of the insertion body.

20. The clamping system of claim 16, further comprising a column oven enclosing the devices and the first and second fluidic assemblies.
